(19) United States
(12) Patent Application Publication
(10) Pub. No.: US 2016/0285918 A1
(43) Pub. Date: Sep. 29, 2016

(54) SYSTEM AND METHOD FOR CLASSIFYING DOCUMENTS BASED ON ACCESS

(71) Applicant: Whitebox Security Ltd., Petach Tikva (IL)

(72) Inventors: Roy PERETZ, Petach Tikva (IL); Maor GOLDBERG, Sunnyvale, CA (US); Eran LEIB, Sunnyvale, CA (US); Shlomi WEXLER, Tel Aviv (IL); Itay MAICHEL, Ra'anana (IL); Aviad CHEN, Kfar Saba (IL)

(21) Appl. No.: 15/083,311

(22) Filed: Mar. 29, 2016

Related U.S. Application Data
(60) Provisional application No. 62/139,730, filed on Mar. 29, 2015.

(51) Int. Cl. H04L 29/06; G06F 17/30

(52) U.S. Cl. CPC H04L 63/205; G06F 17/30598; H04L 63/1425; G06F 17/30011; H04L 63/1416

(57) ABSTRACT

A system for classifying data includes an access monitor, a compliance processor and a classifier. The access monitor monitors access to files in a documentation system. The compliance processor categorizes the files according to pre-determined rules wherein the rules are based on at least one of: access to the files and at least one file property of the files. The classifier classifies the files according to the results of the compliance processor.

### CROSS REFERENCE TO RELATED APPLICATIONS

This application claims priority and benefit from U.S. provisional patent application 62/139,730, filed Mar. 29, 2015, which is incorporated herein by reference.

### FIELD OF THE INVENTION

The present invention relates to monitoring documents generally and classifying documents based on criteria in particular.

### BACKGROUND OF THE INVENTION

Today's fast-paced business-environments require employees to have access to information, where and when they need it. This leads to a constant struggle, where organizations strive to ensure that sensitive data is not overexposed.

It is often necessary to classify the organizational data to be aware of sensitive content, and to ensure that a sensitive document does not fall into the wrong hands. Current methods typically include the analysis of file content and metadata attributes such as author, filename and file size and scanning the content of files to search for pre-defined keywords may give an indication of sensitivity such as “credit card”, “bank” or known patterns such as a credit card sequence of numbers.

### SUMMARY OF THE PRESENT INVENTION

There is provided, in accordance with a preferred embodiment of the present invention, a system for classifying data that includes an access monitor, a compliance processor and a classifier. The access monitor monitors access to files in a documentation system. The compliance processor categorizes the files according to pre-determined rules wherein the rules are based on at least one of: access to the files and at least one file property of the files. The classifier classifies the files according to the results of the compliance processor.

Additionally, in accordance with a preferred embodiment of the present invention, the system further includes a threshold determiner to analyze all accesses to the files over a time period and to determine if the accesses to the files over the specified time period meet a threshold requirement of the rule.

Furthermore, in accordance with a preferred embodiment of the present invention, the threshold rule may have several time periods and different classification according to each time period.

Additionally, in accordance with a preferred embodiment of the present invention, custom file properties, file content such as key words, text patterns, content behavior and wildcards may be used for classification.

In accordance with a preferred embodiment of the present invention, the system may include a rule builder to build the classification rules.

Furthermore, in accordance with a preferred embodiment of the present invention, the system includes a data store to store access information including access performer, time of access, place of access, and/or means of access and to use this information in the classification rules. The data store also stores user information including user position and/or user department and utilizes this information to determine access information. In addition, the system generates access statistics and stores it also in the data store.

Moreover, in accordance with a preferred embodiment of the present invention there is provided, a method for classifying data. The method includes monitoring access to files in a documentation system, categorizing the files according to pre-determined rules which are based on access to the files and/or at least one file property, and classifying the files according to the file categorizations outcome.

Additionally, in accordance with a preferred embodiment of the present invention, the method includes analyzing all accesses to the monitored files over a time period and determining if accesses to the files over the defined time period meet a threshold requirement rule. In accordance with a preferred embodiment of the present invention, the method supports several time periods and classifies the files differently per each time period.

Furthermore, the rules used by the method, according to an embodiment of the present invention, are based on a custom file property and/or on the content of the file, such as specified key words, text patterns, content behavior and/or wildcards.

According to a preferred embodiment of the present invention, the method enables the user to build rules to be used for classification.

Moreover, in accordance with a preferred embodiment of the present invention, the method stores access information that includes: access performer, time of access, place of access and means of access in a data store, and use the stored data in classification rules, and stores user information comprising at least one of: user position and user department and use this information in classification rules.

According to a preferred embodiment of the present invention, the method generates statistics and stores it in the data store.

According to an embodiment of the present invention, the method performs the classification in two steps: creating a subset of files that are accessed according to pre-defined rules and classifying the files according to pre-defined thresholds.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a system for tagging sensitive documents based on access, constructed and operative in accordance with the present invention;

FIG. 2 is a screenshot of the behavioral classification rule creation wizard with an example of an access behavior rule; constructed and operative in accordance with the present invention;

FIG. 3 is a screenshot of the content classification rule creation wizard with an example of a file property/content classification rule, constructed and operative in accordance with the present invention;

FIG. 4 is a schematic illustration of an alternative system to that of FIG. 1, constructed and operative in accordance with the present invention; and

FIG. 5 is an example of a data classification policy, constructed and operative in accordance with the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicants have realized that classifying a document based on a search of keywords, patterns and metadata etc. alone is not particularly efficient and that the content-based classification policies are hard to create.

Applicants have also realized that an alternative way of classifying a document may be through examination of access behavior to the file—i.e. who has accessed the file, when, where and how (via which platform etc.) etc. For example all documents accessed by the finance department or by the CEO may be classified as sensitive. Applicants have further realized that this method may also produce false positives. For example a document accessed by all members of the finance department may be a list of company telephone numbers that is accessed not just by the finance department but also by the whole company. Therefore it should not be classified as sensitive.

Applicants have also realized that a further examination of the access behavior for the listing of files returned may significantly reduce any false positives. For example, for the document containing the list of company telephone numbers, if all accesses to the file are examined over a 1 month time period of time, the results may show that only 10% of the total accesses to the file were from the finance department. The rest may have been from other departments. From this it may be construed that the document is not particularly sensitive to the finance department and therefore does not need to be classified as such. Therefore a rule including a threshold limitation, such as 80% may be added for all files (for example) accessed by the finance department. Therefore for all files accessed by the finance department, if at least 80% of all accesses to the files over a certain period of time, were indeed accessed by members of the finance department, then the file may be classified as “sensitive”.

It will be appreciated that a document classified as “sensitive” (or any other classification) may also help the organization improve their document control and management system. For example it may be necessary for a documentation system to trigger a real time alert for the violation of an access policy. The organization can then decide that access controls for resources that contain certain types of information should be stricter, and that compliance controls for such resources, such as access reviews should be done more often for those particular resources.

It will also be appreciated that efficient file classification may ensure that files are well protected. The classification results of files may also be used to monitor access and permissions usage to ensure that no sensitive data is overexposed or is allowed to become stale. It will also be appreciated that documents may come from within an organization and may be stored on an internal file server or may be stored externally on a cloud based storage system.

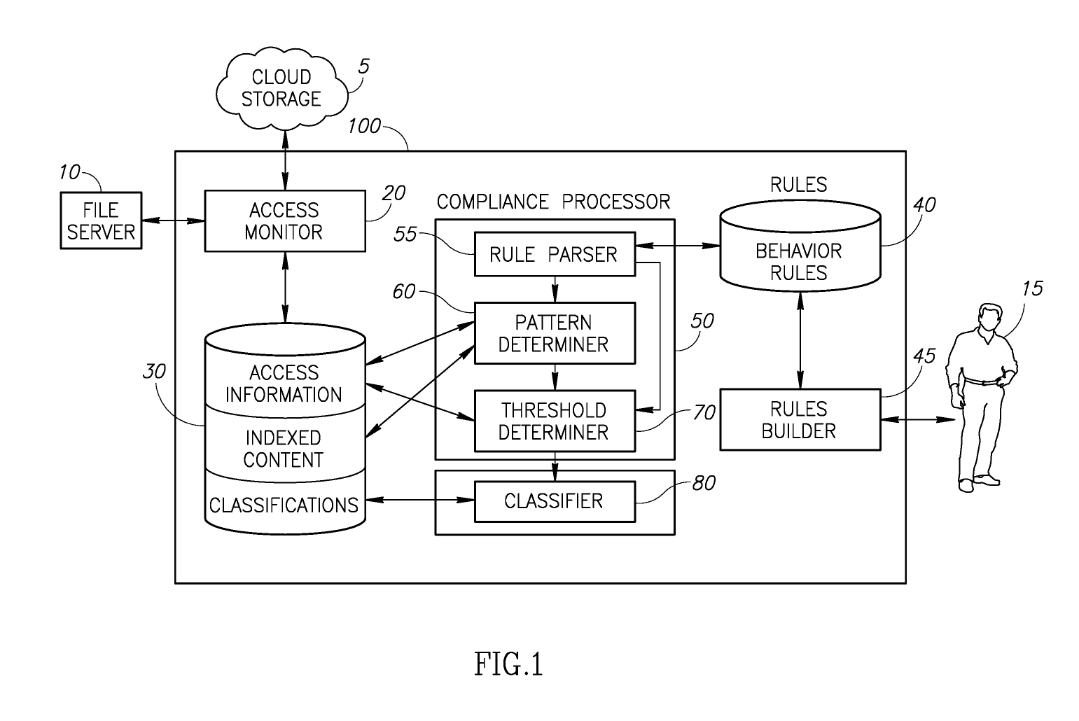

Reference is now made to FIG. 1 which illustrates a system 100 for classifying documents based on access and file properties according to an embodiment of the present invention. System 100 comprises an access monitor 20, an access and classification database 30, a rules database 40, a rules builder 45 and a classification processor 50. Classification processor 50 may further comprise a rule parser 55, a pattern determiner 60, a threshold compliance determiner 70 and a classifier 80.

It will be appreciated that system 100 may be used in conjunction with file server 10 and cloud storage 5 which may hold the pertinent company documents. Access monitor 20 may monitor access to all files held on file server 10 and cloud storage 5. This may include statistics of who accessed the file, including dates, time, access type (via which platform) etc. It will be further appreciated that access monitor 20 may also know information regarding the users themselves—what their position is, what department they work in etc. Thus access monitor 20 may hold information about all accesses by the CEO of the company, members of the finance department etc. Access monitor 20 may store this information on access database 30.

Rules database 40 may hold pre-defined rules and/or rules that were created by a user 15 in order to classify their files as described in detail herein below. It will be appreciated that these rules may be created via rules builder 45 using a rule wizard which it may present to the user 15 via a suitable interface. It will be appreciated that a behavior rule may be based on a query such as who has accessed the file, how, over what time period etc. A behavior rule may also have one or more file related property requirements (such as file extension). The rule may also contain an associated threshold limitation to determine a subset of potentially sensitive (or any other classification) documents based on all accesses to a file over a period of time according to the access feature of the query. It will be further appreciated that the same rule may duplicated and the threshold limitation changed in order to create different levels of classification for the same pattern.

It will be further appreciated that standard file property information may be pre-known and may be available from file server 10 and cloud storage 5 such as file extension, file size, etc. or maybe custom. Custom file properties may be also pre-determined such as author, title etc. For example, a particular file or document may be indexed as having file property author as “CFO” or “ASmith”. Thus files may be further categorized and easily queried. It will be appreciated that custom file property information may also be held on database 30 together with indexed content as discussed in more detail herein below.

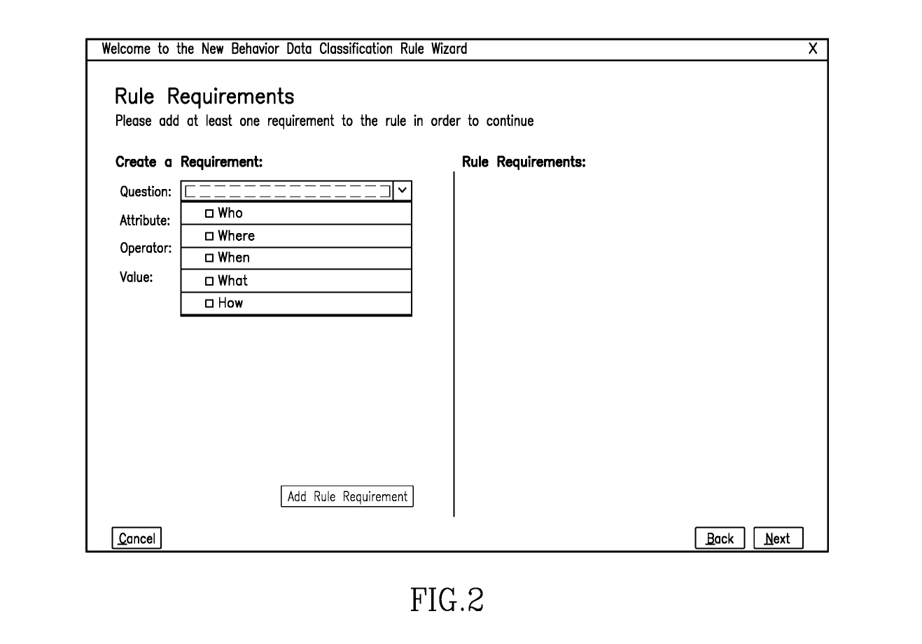

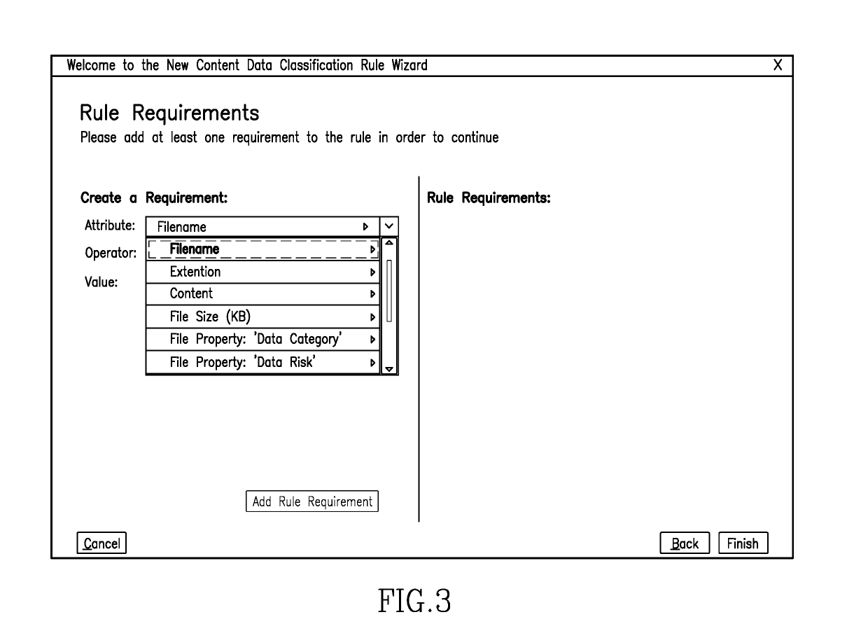

Reference is now made to FIGS. 2 and 3 which illustrate an example typical interface that may be used by rules builder 45 to create rules. FIG. 2 shows an interface for a behavior rule and FIG. 3 shows an interface for a rule based on content and file property as discussed in more detail herein below. It will be appreciated that once rules have been created, rules builder 45 may save them on rules database 40.

Rule parser 55 may receive and parse the pertinent rule in order to extract the required instructions accordingly. As described herein above, a single behavior rule may contain more than one requirement, a pattern query based on access to a file and/or file property requirements and a threshold limit based on all accesses to each individual file falling into the pattern subset over a time period.

Pattern determiner 60 may then determine and create a list of files that meet the desired pattern according to the access and/or indexed file properties held on access database 30.

Once pattern determiner 60 has determined a subset of potentially (as an example classification) “sensitive” files, threshold compliance determiner 70 may check each file within the subset individually against the threshold requirement for the pertinent access behavior rule and the data held in access database 30. As discussed herein above, the threshold may narrow down a subset of potentially “sensitive” files. For example if at least 80% of the total accesses to the pertinent file over the designated time meet the conditions of the rule (such as “accessed by members of the finance department over the last 3 months”), then the file may be determined as “sensitive”.

Classifier 80 may then save a record in database 30 which may classify the pertinent file for future reference. The record may contain the file name, an indication that it has met the requirements of a particular rule, and an indication for the classification. For example, the file “c:\My Folder\Myfile.xlsx” meets the requirements of rule ABC, and the classification is “Sensitive Financial Information”.

It will be appreciated that the process may be both manual and automatic. System 100 may be run on an ad-hoc basis or may be set to run regularly over a pre-set time frame.

In yet another embodiment of the present invention, false positives created by current methods of classification using content analysis (as discussed herein above) may be reduced by complementing these methods of classification using access behavior rules as described herein above. As discussed herein above, current systems typically classify their files using a keyword search such as the words “credit cards” or may search for a particular content pattern etc. For example a document created by the company receptionist containing the words “strictly confidential” could be classified as a “strictly confidential” file based solely on its content. It will therefore be appreciated that a further analysis of the history of the access of the file looking at all accesses over a certain time period may show that 80% of all accesses were made by the finance department of the company and therefore it may be further classified as “strictly confidential financial information”.

It will be appreciated that files from file server 10 or cloud storage 5 may be pre-indexed according to keywords and patterns and that the indexes may also be stored on database 30. The keywords and patterns may be pre-defined, customized or alternatively, user defined. Files may also be indexed according to other content requirements such as wild cards and regular expressions. In this scenario, once rule parser 55 has parsed the incoming rule, pattern determiner 60 may search the indexes on database 30 for content and/or content pattern matches to the pertinent content rule as well as searching for matching access information and/or file property requirements as described herein above. It will be appreciated that if a match is not found, then no results are returned. For example, if a file does not contain the word “classified” and the rule in question requires a match to the word “classified”—no files will be returned and no classification will occur.

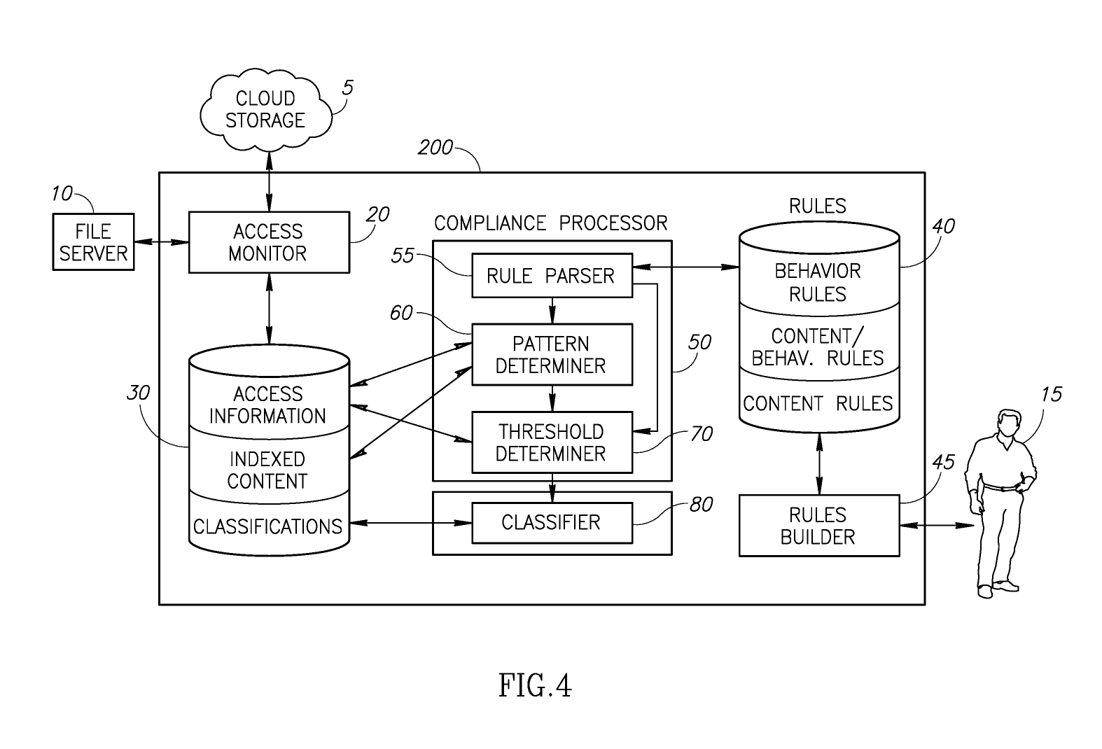

Reference is now made to FIG. 4 which illustrates a system 200 for classifying documents based on access, file properties and content according to an embodiment of the present invention. It will be appreciated that in this scenario, database 30 may store the indexes pertaining to pre-indexed content, file properties, and content patterns etc. classification as described herein above. It will be also appreciated that the functionality of the rest of the elements of system 200 may be similar to those of system 100 as described herein above. In this scenario, rules database 40 may also hold behavior rules, integrated content and behavior rules and content rules. It will be appreciated that some rules may have a pattern query but not necessarily a threshold limitation such as a content rule which may require a match to a content pattern only. In this scenario, pattern determiner 60 may return a subset of files based on content etc. such as all files containing the words “strictly confidential”. Classifier 80 may automatically classify them without the access threshold check.

As described herein above, pattern parser 55 may parse the incoming rule and pattern determiner 60 may create a list of files that meet the desired criteria according to the required pattern by looking at database 30 for both content based classification results indicating files that match the pertinent content query and access information that meet the required behavior limitation. As discussed hereinabove threshold compliance determiner 70 may take the subset of files determined by pattern determiner 60 and examine their accesses over the prescribed period against the specified threshold. Classifier 80 may classify files as described herein above.

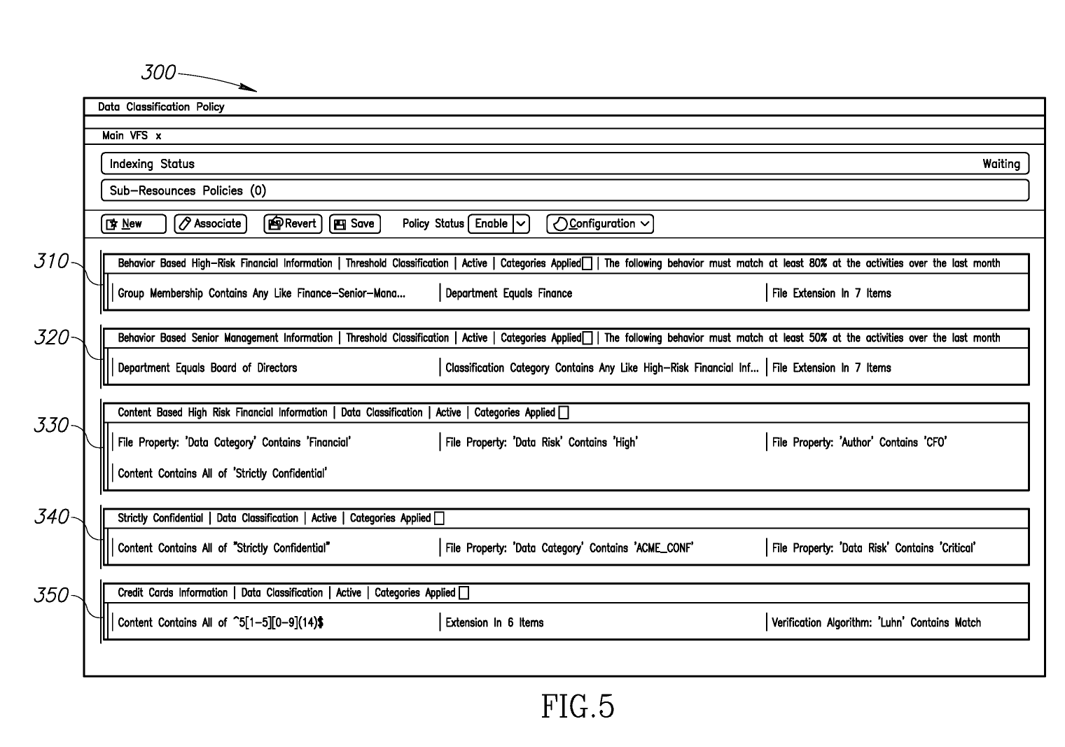

Reference is now made to FIG. 5 which illustrates a typical data classification policy 300 for a company. As is illustrated, policy 300 is made up of five different rules, a behavior rule (310), an integrated content and behavior rule (320) and 3 content rules (330, 340 and 350).

As is shown, rule 310 requires pattern determiner 60 to create a subset of files which were accessed by the group “finance-senior-manager”, that are also members of the finance department and to only consider files with 1 of 7 defined files extensions (such as .pdf, .doc etc.). After the subset of files has been formed, threshold determiner 70 may look at all the accesses to each individual file over the past month. If at least 80% of all accesses to the file over the last month were by members of the group “finance-senior-manager” that are also members of the finance department, then classifier 80 may classify the files as “high risk financial information”

Rule 320 is an integrated behavior and content rule. It requires pattern determiner 60 to create a subset of files that have been accessed by the board of directors, contain high risk financial information (content based) and considers only files with 1 of 7 file extensions. After the subset of files has been formed, threshold determiner 70 may look at all the accesses to each individual file over the past month. If at least 50% of all accesses to the file over the last month were made by members of the board of directors department, then classifier 80 may classify the files as “senior management financial information”.

Rules 330-350 illustrate basic content rules with no threshold limitations. Rule 330 looks for files containing the text “strictly confidential” with a file property named “data category” that contains the text “financial”, a file property named “data risk” that contains the text “high” and that were created by the CFO. Rule 340 looks for files containing the text “*strictly confidential*” (wildcard) with a file property named “data category” containing the text “ACME CONF” and a file property of “data risk” with the text “critical”. Rule 350 looks for files that have 1 of 6 designated file extensions with a particular pattern of characters and then verifies that the pattern complies with the “Luhn Algorithm” (a known credit card number verification algorithm).

Thus a file may be classified as sensitive or as any other characteristic if it meets a pre-determined pattern of access behavior and/or a pre-determined pattern of access behavior combined with a pattern of content limitations and if all accesses to the file over a time period according to the pattern of access behavior meet a threshold percentage.

Unless specifically stated otherwise, as apparent from the preceding discussions, it is appreciated that, throughout the specification, discussions utilizing terms such as “processing,” “computing,” “calculating,” “determining,” or the like, refer to the action and/or processes of a computer, computing system, or similar electronic computing device that manipulates and/or transforms data represented as physical, such as electronic, quantities within the computing system's registers and/or memories into other data similarly represented as physical quantities within the computing system's memories, registers or other such information storage, transmission or display devices.

Embodiments of the present invention may include apparatus for performing the operations herein. This apparatus may be specially constructed for the desired purposes, or it may comprise a general-purpose computer selectively activated or reconfigured by a computer program stored in the computer. Such a computer program may be stored in a computer readable storage medium, such as, but not limited to, any type of disk, including floppy disks, optical disks, magnetic-optical disks, read-only memories (ROMs), compact disc read-only memories (CD-ROMs), random access memories (RAMs), electrically programmable read-only memories (EPROMs), electrically erasable and programmable read only memories (EEPROMs), magnetic or optical cards, Flash memory, or any other type of media suitable for storing electronic instructions and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description above. In addition, embodiments of the present invention are not described with reference to any particular programming language. It will be appreciated that a variety of programming languages may be used to implement the teachings of the invention as described herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A system for classifying data comprising:
an access monitor to monitor access to files in a documentation system;
a compliance processor to categorize said files according to pre-determined rules wherein said rules are based on at least one of: access to said files and at least one file property of said files; and
a classifier to classify said files according to the result of said compliance processor.

2. The system according to claim 1 and further comprising a threshold determiner to analyze all accesses to said files over a time period and to determine if said accesses to said files over said time period meet a threshold requirement of said rule.

3. The system according to claim 2 and wherein said threshold determiner has several time periods and wherein said classifier comprises means to classify said files differently per each of said time periods.

4. The system according to claim 1 wherein said file property in said rules is further based on at least one custom file property.

5. The system according to claim 1 wherein said rules are further based on content of said files.

6. The system according to claim 5 and wherein said content is at least one of: key words, text patterns, content behavior and wildcards.

7. The system according to claim 1 and also comprising a rule builder to enable a user to build said rules.

8. The system according to claim 1 and also comprising a data store to store access information comprising at least one of: access performer, time of access, place of access, means of access.

9. The system according to claim 8 and wherein said rules are further based on said access information.

10. The system according to claim 8 and wherein said access monitor comprises a statistic generator to generate access statistics.

11. The system according to claim 8 and wherein said classifier is connected to said data store to store classification data of said files.

12. The system according to claim 8 and wherein said data store stores user information comprising at least one of: user position and user department.

13. The system according to claim 12 and wherein said access monitor is connected to said data store and comprises means to utilize said user information to determine said access information.

14. The system according to claim 3 and wherein said threshold determiner comprises rules applicable to a subset of said files wherein said subset is the outcome of applying rules based on access to said files and at least one file property of said files.

15. A method for classifying data, the method comprising:
monitoring access to files in a documentation system;
categorizing said files according to pre-determined rules wherein said rules are based on at least one of: access to said files and at least one file property of said files; and
classifying said files according to the result of said compliance processor.

16. The method according to claim 15 and further comprising analyzing all accesses to said files over a time period and determining if said accesses to said files over said time period meet a threshold requirement of said rule.

17. The method according to claim 16 and wherein analyzing access according to several time periods and classifying said files differently per each of said time periods.

18. The method according to claim 15 wherein said file property in said rules is further based on at least one custom file property.

19. The method according to claim 15 wherein said rules are further based on content of said files.

20. The method according to claim 19 and wherein said content is at least one of: key words, text patterns, content behavior and wildcards.

21. The method according to claim 15 and also includes a rule building method to enable a user to build said rules.

22. The method according to claim 15 and further comprising storing access information comprising at least one of: access performer, time of access, place of access, means of access.

23. The method according to claim 22 and wherein said rules are further based on said access information.

24. The method according to claim 22 and also comprising generating access statistics.

25. The method according to claim 22 and also comprising storing classification data of said files.

26. The method according to claim 22 and wherein storing user information comprises at least one of: user position and user department.

27. The method according to claim 26 and also comprising utilizing said user information to determine said access information.

28. The method according to claim 17 and wherein analyzing access to said files is performed after applying rules based on access to said files and at least one file property of said files.
